(19) United States
(12) Patent Application Publication
(10) Pub. No.: US 2012/0269121 A1
(43) Pub. Date: Oct. 25, 2012

(54) BASE STATION APPARATUS FOR TRANSMITTING OR RECEIVING A SIGNAL INCLUDING PREDETERMINED INFORMATION

(75) Inventors: Makoto NAGAI, Kakamigahara City (JP); Ken Nakaoka, Ichinomiya City (JP)

(73) Assignee: SANYO ELECTRONIC CO., LTD., Osaka (JP)

(21) Appl. No.: 13/425,162

(22) Filed: Mar. 20, 2012

Related U.S. Application Data
(63) Continuation of application No. PCT/JP2011/004498, filed on Aug. 8, 2011.

(30) Foreign Application Priority Data
Aug. 9, 2010 (JP) 2010-178636
Sep. 10, 2010 (JP) 2010-203116

(51) Int. Cl. H04W 88/00

(52) U.S. Cl. 370/328

(57) ABSTRACT

A setting unit defines the first frame and the second frame and selects use of the first frame or the second frame. A generation unit generates control information which is defined by the same format regardless of the selection by the setting unit and which includes at least information related to the base station broadcast period. The generation unit puts information related to the ratio between the priority period and the general period into the control information and reflects the selection by the setting unit to the ratio. The modem unit and the RF unit broadcast a packet signal including the control information in the base station broadcast period.

### BACKGROUND OF THE INVENTION

1. Field of the Invention

The present invention relates to a communication technique, in particular to a base station apparatus for transmitting or receiving a signal including predetermined information.

2. Description of the Related Art

Road-to-vehicle communication is studied in order to prevent intersection collision from occurring. In the road-to-vehicle communication, information related to a state of an intersection is transmitted between a road-side machine and a vehicle-mounted apparatus. In the road-to-vehicle communication, it is necessary to install a road-side machine, so that labor and cost increase.

On the other hand, in inter-vehicle communication, that is, in a form in which information is transmitted between vehicle-mounted apparatuses, it is not necessary to install a road-side machine. In this case, for example, current position information is detected in real time by GPS (Global Positioning System) or the like and the position information is exchanged between the vehicle-mounted apparatuses, so that roads through which one vehicle and the other vehicle respectively reach the intersection are determined.

Ina wireless LAN (Local Area Network) compatible with a standard such as IEEE802.11 or the like, an access control function called CSMA/CA (Carrier Sense Multiple Access with Collision Avoidance) is used. Therefore, in the wireless LAN, the same wireless channel is shared by a plurality of terminal apparatuses. In such CSMA/CA, a packet signal is transmitted after checking that another packet signal is not transmitted by using carrier sense.

On the other hand, when a wireless LAN is applied to inter-vehicle communication such as ITS (Intelligent Transport Systems), it is necessary to transmit information to an unspecified large number of terminal apparatuses, so that it is desired that a signal is transmitted by broadcast. However, at an intersection or the like, it is estimated that the number of collisions of packet signals increases because the increase of the number of vehicles, that is, the increase of the terminal apparatuses, causes traffic to increase. As a result, data included in the packet signal is not transferred to another terminal apparatus. If such a situation occurs in the inter-vehicle communication, the object of preventing intersection collision from occurring is not achieved. On the other hand, there are intersections where the number of terminal apparatuses does not increase so much. At such an intersection, a simple communication control is desired rather than reducing the collision probability of packet signals. Therefore, highly flexible inter-vehicle communication is desired to be performed. Further, if road-to-vehicle communication is performed in addition to the inter-vehicle communication, there may be various communication forms. In this case, it is required to reduce influence between the inter-vehicle communication and the road-to-vehicle communication.

### SUMMARY OF THE INVENTION

The present invention is made in view of the above situation and an object of the present invention is to provide a technique that realizes highly flexible communication between terminals.

To solve the above problem, a base station apparatus of an aspect of the present invention is a base station apparatus for controlling communication between terminals. The base station apparatus includes a selection unit configured to define a first frame in which a base station broadcast period for the base station apparatus to broadcast a packet signal and a general period which has a predetermined length and in which a terminal apparatus can broadcast a packet signal are time multiplexed, to define a second frame in which the base station broadcast period, the general period, and a priority period which is formed by a plurality of slots and in which a terminal apparatus can broadcast a packet signal in each slot are time multiplexed, and to select use of the first frame or the second frame, a generation unit configured to generate control information which is defined by the same format and which includes at least information related to the base station broadcast period regardless of the selection by the selection unit, and a broadcast unit configured to broadcast a packet signal including the control information generated by the generation unit in the base station broadcast period. The generation unit puts information related to a ratio between the priority period and the general period into the control information and reflects the selection by the selection unit to the ratio.

A certain combination of the components described above and a representation of the present invention transformed between a method, an apparatus, a system, a recording medium, and a computer program are also effective as an aspect of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram showing a configuration of a communication system according to an embodiment of the present invention;

FIG. 2 is a diagram showing a configuration of abase station apparatus in FIG. 1;

FIGS. 3(a) to 3(d) are diagrams showing a format of a frame defined in the communication system in FIG. 1;

FIGS. 4(a)to 4(c) are diagrams showing a configuration of a subframe in FIGS. 3(a) to 3(d);

FIGS. 5(a) and 5(b) are diagrams showing a format of a MAC frame stored in a packet signal defined in the communication system in FIG. 1;

FIGS. 6(a) to 6(c) are diagrams showing another configuration of a subframe in FIGS. 3(a) to 3(d);

FIGS. 7(a) to 7(e) are diagrams showing a setting example of an inter-vehicle transmission period in FIGS. 3(a)to 3(d);

FIGS. 8(a) to 8(e) are diagrams showing another setting example of an inter-vehicle transmission period in FIGS. 3(a) to 3(d);

FIG. 9 is a diagram showing a configuration of a terminal apparatus mounted on a vehicle in FIG. 1;

FIG. 10 is a diagram showing a configuration of another terminal apparatus mounted on a vehicle in FIG. 1;

FIG. 11 is a flowchart showing a transmission process in the terminal apparatus in FIG. 9 or 10;

FIG. 12 is a flowchart showing a transmission process in the terminal apparatus in FIG. 9;

FIG. 13 is a diagram showing another configuration of a priority period shown in FIG. 4(b); and

FIG. 14 is a diagram showing a configuration of a subframe according to a modified example of the present invention.

### DETAILED DESCRIPTION OF THE INVENTION

The invention will now be described by reference to the preferred embodiments. This does not intend to limit the scope of the present invention, but to exemplify the invention.

An outline of the present invention will be described before giving specific descriptions. An embodiment of the present invention relates to a communication system that performs inter-vehicle communication between terminal apparatuses mounted on vehicles as well as performs road-to-vehicle communication from a base station installed at an intersection or the like to a terminal apparatus. In the inter-vehicle communication, the terminal apparatus uses broadcast to transmit a packet signal including information (hereinafter referred to as “data”) such as speed and position of the vehicle. Another terminal apparatus receives the packet signal and recognizes the approach of the vehicle on the basis of the data. Here, a base station apparatus repetitively defines frames including a plurality of subframes. For the road-to-vehicle communication, the base station selects one of a plurality of subframes and uses broadcast to transmit a packet signal including control information and the like in a time period corresponding to a front portion of the selected subframe.

The control information includes information related to a time period (hereinafter referred to as “road-to-vehicle transmission period”) for the base station to broadcast the packet signal. The terminal apparatus identifies the road-to-vehicle transmission period on the basis of the control information and transmits a packet signal in a time period other than the road-to-vehicle transmission period. In this way, the road-to-vehicle communication and the inter-vehicle communication are time division multiplexed, so that collision probability of packet signals in both communications is reduced. In other words, the terminal apparatus recognizes content of the control information, so that interference between the road-to-vehicle communication and the inter-vehicle communication is reduced. A time period for the inter-vehicle communication (hereinafter referred to as “inter-vehicle transmission period”) is formed by time division multiplexing of priority period and general period. The priority period is formed by a plurality of slots and the terminal apparatus transmits a packet signal in one of the slots. The general period is a time period having a predetermined length and the terminal apparatus transmits a packet signal by the CSMA method in the general period. A terminal apparatus that cannot receive the control information from the base station apparatus, that is, a terminal apparatus located outside of an area formed by the base station apparatus, transmits a packet signal by the CSMA method regardless of the configuration of the frame.

Here, in addition to the above frame configuration, a frame (hereinafter referred to as “first frame”) that does not include a priority period is also defined. On the other hand, the frame that includes a priority frame is referred to as “second frame”. In the priority period, communication is performed slot by slot, so that if a process for reducing the collision of packet signals is performed, the collision probability of packet signals in the priority period tends to be lower than the collision probability of packet signals in the general period. Therefore, a process that uses the priority period is required to be a higher level process than a process that uses the general period. When a communication system service is started, it is desired that the use of the communication system is rapidly expanded even if only a simple process can be performed. In view of the above situation, it is expected that, first, terminal apparatuses that can perform communication only in the general period are used, and as the use of the communication system is expanded, terminal apparatuses that can perform communication in both the priority period and the general period are used. In a period of transition, both types of terminal apparatuses are used. It is desired that the configuration of the base station apparatus is not changed even if various types of terminal apparatuses are used.

To cope with the above situation, the communication system according to the present embodiment performs the processes described below. The base station apparatus broadcasts control information defined by a common format regardless of whether the first frame is used or the second frame is used. A broadcasted signal includes information (hereinafter referred to as “priority-general ratio”) related to a ratio of the priority period and the general period in a frame. Whether the first frame is used or the second frame is used is determined by a value of the priority-general ratio. For example, if the first frame is used, the priority-general ratio is represented as “0:1”. The terminal apparatus understands the frame configuration on the basis of the priority-general ratio and identifies the priority period and the general period. Although the priority period and the general period are used in the description below, the priority period and the general period may be replaced by the first period and the second period respectively.

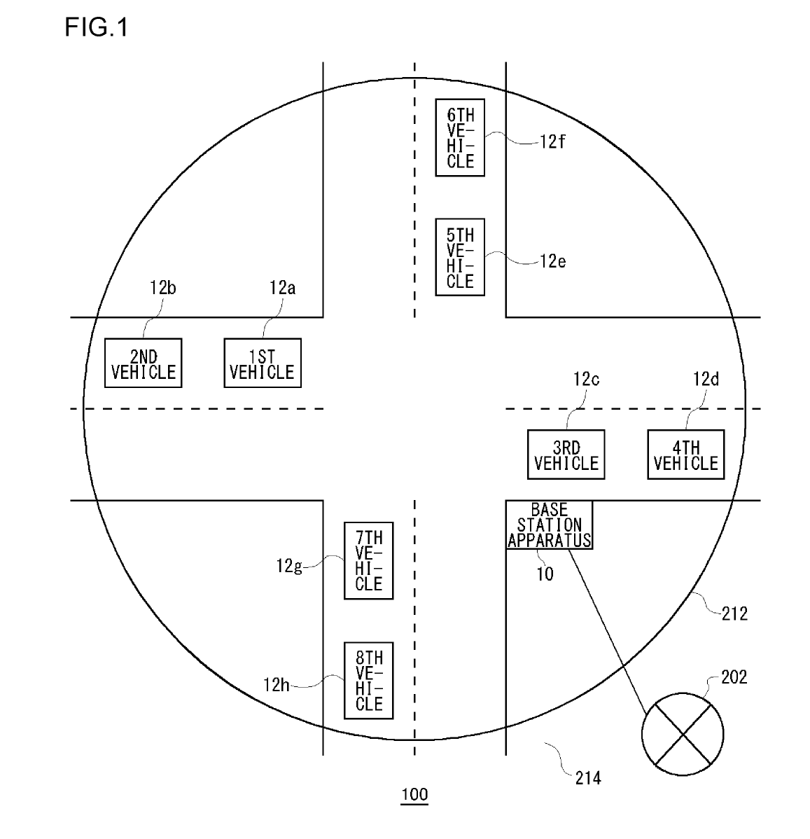

FIG. 1 shows a configuration of a communication system 100 according to the embodiment of the present invention. FIG. 1 is a diagram of one intersection as seen from above. The communication system 100 includes a base station apparatus 10, a first vehicle 12a, a second vehicle 12b, a third vehicle 12c, a fourth vehicle 12d, a fifth vehicle 12e, a sixth vehicle 12f, a seventh vehicle 12g, an eighth vehicle 12h , and a network 202. The first to the eighth vehicles are collectively called “vehicle 12”. A terminal apparatus not shown in FIG. 1 is mounted on each vehicle 12. An area 212 is formed around the base station apparatus 10 and an outside area 214 is formed outside the area 212.

As shown in FIG. 1, a road in the horizontal direction in FIG. 1, that is, a road in the left-right direction, and a road in the vertical direction in FIG. 1, that is, a road in the up-down direction, intersect with each other at the center of FIG. 1. Here, in FIG. 1, the upper side corresponds to the “north”, the left side corresponds to the “west”, the lower side corresponds to the “south”, and the right side corresponds to the “east”. The section at which the two roads intersect with each other is the “intersection”. The first vehicle 12a and the second vehicle 12b move from the left to the right. The third vehicle 12c and the fourth vehicle 12d move from the right to the left. The fifth vehicle 12e and the sixth vehicle 12f move downward. The seventh vehicle 12g and the eighth vehicle 12h move upward.

In the communication system 100, the base station apparatus 10 is disposed at the intersection. The base station apparatus 10 controls communication between the terminal apparatuses. The base station apparatus 10 repetitively generates frames including a plurality of subframes on the basis of a signal received from a GPS satellite not shown in FIG. 1 and a frame formed by another base station apparatus 10 not shown in FIG. 1. Here, it is defined that the road-to-vehicle transmission period can be set in a front portion of each subframe. The base station apparatus selects a subframe in which the road-to-vehicle transmission period is not set by another base station apparatus 10 from a plurality of subframes. The base station apparatus 10 sets the road-to-vehicle transmission period in the front portion of the selected subframe. The base station apparatus 10 broadcasts a packet signal in the set road-to-vehicle transmission period.

A plurality of types of data are assumed to be included in the packet signal. One is data such as traffic jam information and construction information, and another one is data related to the slots included in the priority period. The latter one includes a slot that is not used by any terminal apparatus (hereinafter referred to as “empty slot”), a slot that is used by one terminal apparatus (hereinafter referred to as “in-use slot”), and a slot that is used by a plurality of terminal apparatuses (hereinafter referred to as “collision slot”). A packet signal including data such as traffic jam information and construction information (hereinafter referred to as “RSU packet signal”) and a packet signal including data related to the slots (hereinafter referred to as “control packet signal”) are generated separately from each other. The RSU packet signal and the control packet signal are collectively called “packet signal”.

When a terminal apparatus receives a packet signal from the base station apparatus 10, the terminal apparatus generates a frame on the basis of information included in the packet signal. As a result, a frame generated by each of a plurality of terminal apparatuses is synchronized with a frame generated by the base station apparatus 10. Here, if a terminal apparatus can receive a packet signal from the base station apparatus 10, the terminal apparatus is located in the area 212. When a terminal apparatus is located in the area 212, the terminal apparatus broadcasts a packet signal in one of the slots included in the priority period, or the terminal apparatus broadcasts a packet signal by a carrier sense in the general period. Therefore, TDMA is performed in the priority period and the CSMA/CA is performed in the general period.

In the next frame, the terminal apparatus selects a subframe whose relative timing is the same. In particular, in the priority period, in the next frame, the terminal apparatus selects a slot whose relative timing is the same. Here, the terminal apparatus receives data and stores the data in a packet signal. For example, the data includes information related to a location. The terminal apparatus also stores the control information in the packet signal. As a result, the control information transmitted from the base station apparatus 10 is transferred by the terminal apparatus. On the other hand, if it is estimated that the terminal apparatus is located in the outside area 214, the terminal apparatus broadcasts a packet signal by performing the CSMA/CA regardless of the configuration of the frame. There are a terminal apparatus that can perform only the CSMA/CA and a terminal apparatus that can perform the TDMA in addition to the CSMA/CA. The base station apparatus 10 generates either the first frame or the second frame. Here, whether the first frame is used or the second frame is used is set by a business entity.

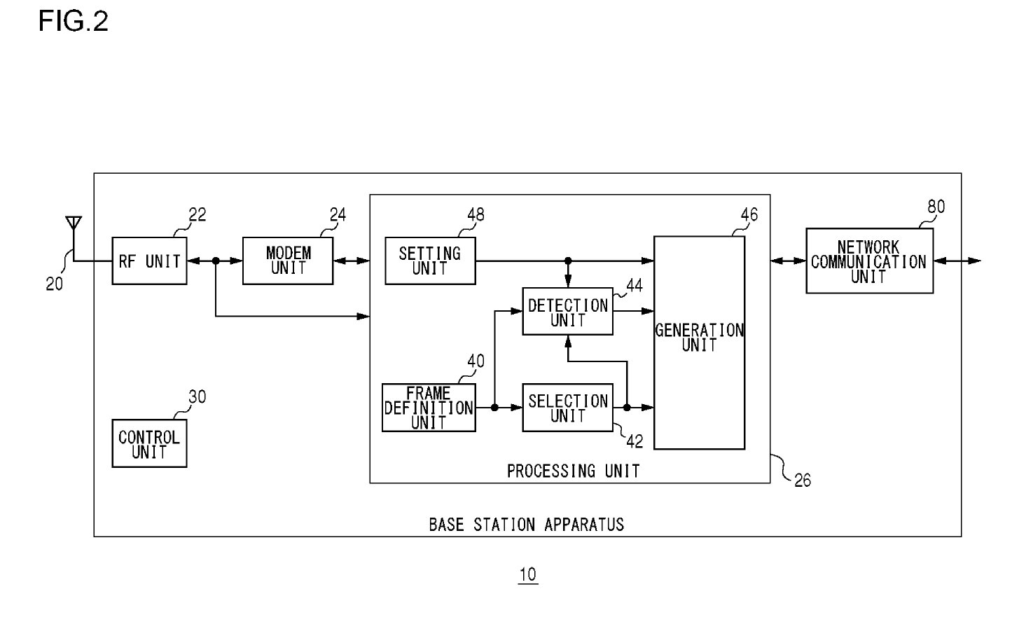

FIG. 2 shows a configuration of the base station apparatus 10. The base station apparatus 10 includes an antenna 20, an RF unit 22, a modem unit 24, a processing unit 26, a control unit 30, and a network communication unit 80. The processing unit 26 includes a frame definition unit 40, a selection unit 42, a detection unit 44, a generation unit 46, and a setting unit 48. As a receiving process, the RF unit 22 receives a packet signal from a terminal apparatus or another base station apparatus 10 that are not shown in FIG. 2 through the antenna 20. The RF unit 22 converts the frequency of the received packet signal having a radio frequency and generates a baseband packet signal. Further, the RF unit 22 outputs the baseband packet signal to the modem unit 24. Generally, the baseband packet signal is formed by an in-phase component and an quadrature component, so that two signal lines should be shown, however, here, only one signal line is shown to clarify the diagram. The RF unit 22 includes an LNA (Low Noise Amplifier), a mixer, an AGC, and an A/D convertor.

As a transmission process, the RF unit 22 converts the frequency of the baseband packet signal inputted from the modem unit 24 and generates a packet signal having a radio frequency. Further, the RF unit 22 transmits the packet signal having a radio frequency from the antenna 20 in the road-to-vehicle transmission period. The RF unit 22 also includes a PA (Power Amplifier), a mixer, and a D/A convertor.

As a receiving process, the modem unit 24 demodulates the baseband packet signal from the RF unit 22. Further, the modem unit 24 outputs the demodulated result to the processing unit 26. As a transmission process, the modem unit 24 modulates data from the processing unit 26. Further, the modem unit 24 outputs the modulated result to the RF unit 22 as a baseband packet signal. Here, the communication system 100 conforms to an OFDM (Orthogonal Frequency Division Multiplexing) modulation method, so that the modem unit 24 also performs FFT (Fast Fourier Transform) as a receiving process and also performs IFFT (Inverse Fast Fourier Transform) as a transmission process.

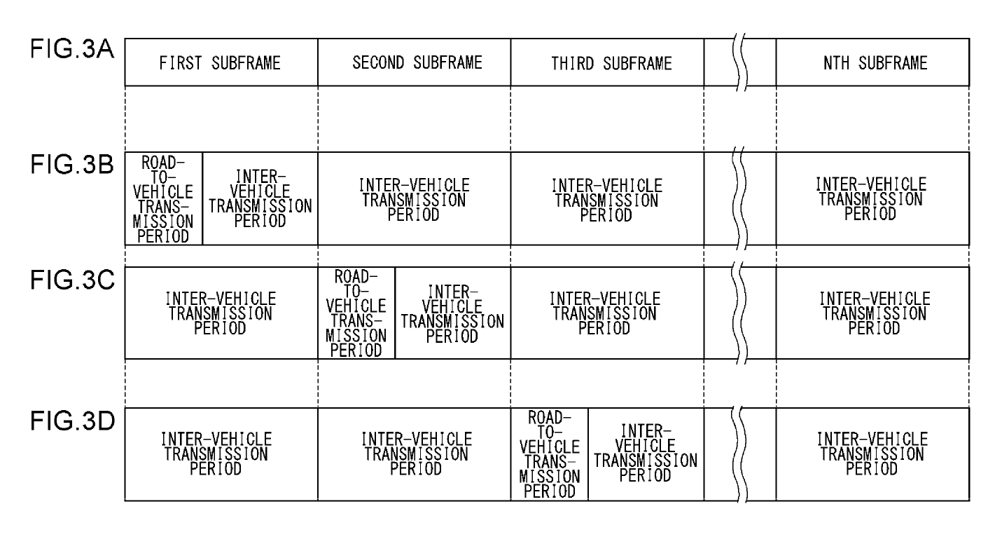

The frame definition unit 40 receives a signal from a GPS satellite not shown in FIG. 2 and obtains information of the time of day on the basis of the received signal. A publicly known technique may be used to obtain the time of day, so that the description of the technique will be omitted. The frame definition unit 40 generates a plurality of frames on the basis of the time of day. For example, the frame definition unit 40 generates 10 frames of “100 msec” by dividing a time period of “1 sec” into 10 time periods on the basis of the timing shown by the information of the time of day. By repeating such a process, it is defined so that the frame is repeated. The frame definition unit 40 may detect the control information from the demodulation result and generate a frame on the basis of the detected control information. Such a process corresponds to generating a frame synchronized with the timing of the frame formed by another base station apparatus 10. FIGS. 3(a) to 3(d) show a format of a frame defined in the communication system 100. FIG. 3(a) shows a configuration of the frame. The frame includes N subframes from a first subframe to an N-th subframe. For example, if the length of the frame is 100 msec and N is 8, subframes having a length of 12.5 msec are defined. N may be a number other than 8. FIGS. 3(b) to 3(d) will be described later. Let us return to FIG. 2.

The selection unit 42 selects a subframe in which the road-to-vehicle transmission period should be set from a plurality of subframes included in the frame. Specifically, the selection unit 42 receives a frame defined by the frame definition unit 40. A demodulation result from another base station apparatus 10 or a terminal apparatus that are not shown in FIG. 2 is inputted into the selection unit 42 via the RF unit 22 and the modem unit 24. The selection unit 42 extracts a demodulation result from another base station apparatus 10 from the inputted modulation results. The extraction method will be described later. The selection unit 42 identifies a subframe whose demodulation result is received, so that the selection unit 42 identifies a subframe whose demodulation result is not received. This corresponds to identifying a subframe in which the road-to-vehicle transmission period is not set by another base station apparatus 10, that is, identifying an unused subframe. If there are a plurality of unused subframes, the selection unit 42 randomly selects one subframe. If there are no unused subframes, that is, if each of a plurality of subframes is used, the selection unit 42 obtains received powers corresponding to demodulation results and preferentially selects a subframe whose received power is small.

FIG. 3(b) shows a configuration of a frame generated by a first base station apparatus 10a. The first base station apparatus 10a sets the road-to-vehicle transmission period in the front portion of the first subframe. The first base station apparatus 10a sets the inter-vehicle transmission period following the road-to-vehicle transmission period in the first subframe. The inter-vehicle transmission period is a time period in which a terminal apparatus can broadcast a packet signal. In other words, it is defined that the first base station apparatus 10a can broadcast a packet signal in the road-to-vehicle transmission period which is the first time period in the first subframe and a terminal apparatus can broadcast a packet signal in the inter-vehicle transmission period other than the road-to-vehicle transmission period in the frame. Further, the first base station apparatus 10a sets only the inter-vehicle transmission period in the second to the N-th subframes.

FIG. 3(c) shows a configuration of a frame generated by a second base station apparatus 10b. The second base station apparatus 10b sets the road-to-vehicle transmission period in the front portion of the second subframe. Further, the second base station apparatus 10b sets the inter-vehicle transmission period in a portion following the road-to-vehicle transmission period in the second subframe, the first subframe, and the third to the N-th subframes. FIG. 3(d) shows a configuration of a frame generated by a third base station apparatus 10c. The third base station apparatus 10c sets the road-to-vehicle transmission period in the front portion of the third subframe. Further, the third base station apparatus 10c sets the inter-vehicle transmission period in a portion following the road-to-vehicle transmission period in the third subframe, the first subframe, the second subframe, and the fourth to the N-th subframes. In this way, a plurality of base station apparatuses 10 respectively select subframes different from each other and set the road-to-vehicle transmission period in the front portion of the selected subframe. Let us return to FIG. 2. The selection unit 42 outputs a subframe number of the selected subframe to the detection unit 44 and the generation unit 46.

The setting unit 48 has an interface for receiving an instruction from the business entity and receives a parameter setting instruction through the interface. For example, the interface is a button and the setting unit 48 receives the parameter setting instruction by an input to the button. The interface may be a connection terminal connected to the network communication unit 80 describe later. In this case, the setting unit 48 receives the parameter setting instruction through the network communication unit 80, a network 202 not shown in FIG. 2, and a PC not shown in FIG. 2. Here, the parameter setting instruction defines whether the first frame is used or the second frame is used. This can be said that the setting unit 48 selects whether the first frame or the second frame is used. When the first frame is used, the priority-general ratio maybe included in the setting instruction. The setting unit 48 outputs the received setting instruction to the detection unit 44 and the generation unit 46.

The detection unit 44 receives the setting instruction from the setting unit 48. When the setting instruction is to use the first frame, the detection unit 44 performs no process. When the setting instruction is to use the second frame, the detection unit 44 identifies whether each of a plurality of slots included in the priority period is unused, in-use, or in a state in which collision occurs. Prior to the description of the process of the detection unit 44, here, a configuration of the subframe in the second frame will be described.

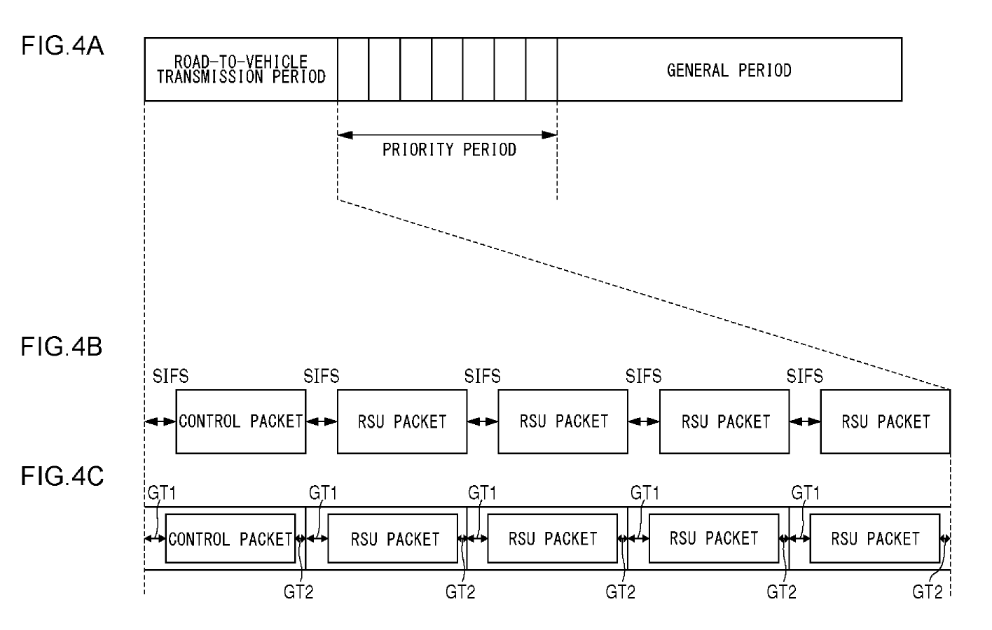

FIGS. 4(a) to 4(c) show a configuration of the subframe. As shown in FIG. 4(a), one subframe includes the road-to-vehicle transmission period, the priority period, and the general period in this order. In the road-to-vehicle transmission period, the base station apparatus 10 broadcasts a packet signal. The priority period is formed by time division multiplexing of a plurality of slots, and a terminal apparatus 14 can broadcast a packet signal in each slot in the priority period. The general period has a predetermined length, and the terminal apparatus 14 can broadcast a packet signal in the general period. The priority period and the general period correspond to the inter-vehicle transmission periods of FIG. 3(b) and the like. When a subframe does not include the road-to-vehicle transmission period, the subframe includes the priority period and the general period in this order. In this case, the road-to-vehicle transmission period is also the priority period. Here, the general period may also be formed by time division multiplexing of a plurality of slots. FIGS. 4(b) to 4(c) will be described later. Let us return to FIG. 2.

The detection unit 44 measures the received power of each slot and also measures the error rate of each slot. An example of the error rate is BER (Bit Error Rate). When the received power is lower than a received power threshold, the detection unit 44 determines that the slot is unused (hereinafter, such a slot is referred to as “empty slot”). On the other hand, when the received power is higher than or equal to the received power threshold and the error rate is lower than an error rate threshold, the detection unit 44 determines that the slot is in use (hereinafter, such a slot is referred to as “in-use slot”). When the received power is higher than or equal to the received power threshold and the error rate is higher than or equal to the error rate threshold, the detection unit 44 determines that collision occurs in the slot (hereinafter, such a slot is referred to as “collision slot”). The detection unit 44 performs the process described above on all the slots and outputs the results of the processes (hereinafter referred to as “detection results”) to the generation unit 46.

The generation unit 46 receives the setting instruction from the setting unit 48 and receives the subframe number from the selection unit 42. When the setting instruction is to use the second frame, the generation unit 46 receives the detection results from the detection unit 44. First, a case in which the setting instruction is to use the second frame will be described. The generation unit 46 sets the road-to-vehicle transmission period in the subframe of the received subframe number and generates a control packet signal and an RSU packet signal to be broadcast in the road-to-vehicle transmission period. FIG. 4(b) shows an arrangement of the packet signals in the road-to-vehicle transmission period. As shown in FIG. 4 (b), one control packet signal and a plurality of RSU packet signals are arranged in the road-to-vehicle transmission period. Here, two adjacent packet signals are separated from each other by SIFS (Short Interframe Space). The road-to-vehicle transmission period may include a plurality of slots and a packet signal may be arranged in each slot as shown in FIG. 4(c) instead of the case of FIG. 4(b) in which packet signals are arranged with the SIFS distance in-between in the road-to-vehicle transmission period. As shown in FIG. 4(c), the control packet signal and the RSU packet signals are arranged in the slots respectively. Here, a guard time GT1 is provided from the front of the slot and a packet signal is arranged following the guard time GT1. A guard time GT2 is provided following the packet signal. Let us return to FIG. 2.

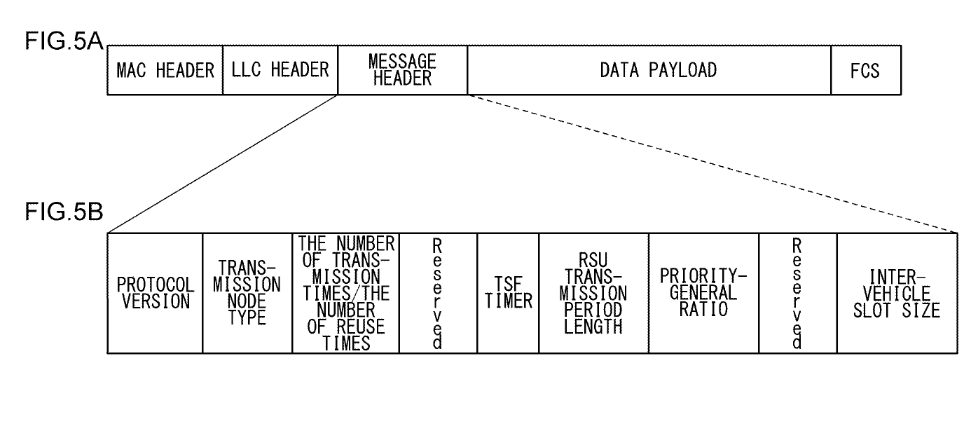

Here, configurations of the control packet signal and the RSU packet signal will be described. FIGS. 5(a) to 5(b) show a format of a MAC frame stored in a packet signal defined in the communication system 100. FIG. 5(a) shows a format of the MAC frame. The MAC frame includes “MAC header”, “LLC header”, “message header”, “data payload”, and “FCS” in order from the front. When the detection results are included in the data payload, a packet signal storing the MAC frame corresponds to the control packet signal. When the generation unit 46 receives data such as traffic jam information and construction information from the network communication unit 80, the generation unit 46 puts the data in the data payload. A packet signal storing such a MAC frame corresponds to the RSU packet signal. Here, the network communication unit 80 is connected to the network 202 not shown in the drawings. A packet signal that is broadcast in the priority period and the general period stores the MAC frame shown in FIG. 5(a).

FIG. 5(b) is a diagram showing a configuration of the message header generated by the generation unit 46. The message header includes “protocol version”, “transmission node type”, “the number of transmission times/the number of reuse times”, “TSF timer”, “RSU transmission period length”, “priority-general ratio”, and “inter-vehicle slot size”. The protocol version indicates a version of the corresponding protocol. The transmission node type is represented by a plurality of bits and the most significant bit indicates the type of the transmission node. The base station apparatus 10 and the terminal apparatus are defined as the types of the transmission node. Another bit indicates whether the packet signal is the control packet signal or the RSU packet signal when the type of the transmission node is the base station apparatus 10.

The number of transmission times/the number of reuse times indicates an index of effectiveness when the message header is transferred by the terminal apparatus. The TSF timer indicates a transmission time. The RSU transmission period length indicates the length of the road-to-vehicle transmission period and it can be said that the RSU transmission period length is information related to the road-to-vehicle transmission period. The priority-general ratio indicates a ratio of the priority period and the general period, and for example, indicates a ratio between both periods in a subframe. If the first frame is used, the priority-general ratio is represented as “priority: general=0:1”. On the other hand, if the second frame is used, the priority-general ratio is represented as “priority: general=2:1, 1:1, 2:1, and the like”. It is possible to define a priority-general ratio where all periods are the priority periods. In this case, the priority-general ratio is represented as “priority: general=1:0”. In the description below, the second frame includes a frame in which all periods are the priority periods. In other words, any frame which includes the priority period is the second frame. The inter-vehicle slot size indicates the size of a slot included in the priority period. Here, the inter-vehicle slot size is shown using the number of units. One unit is two OFDM symbols. In this way, the message header includes the priority-general ratio, and the selection by the setting unit 48, that is, whether the first frame is used or the second frame is used, is reflected to the priority-general ratio. As a result, it is defined that the format of the message header is the same regardless of the selection by the setting unit 48. Let us return to FIG. 2.

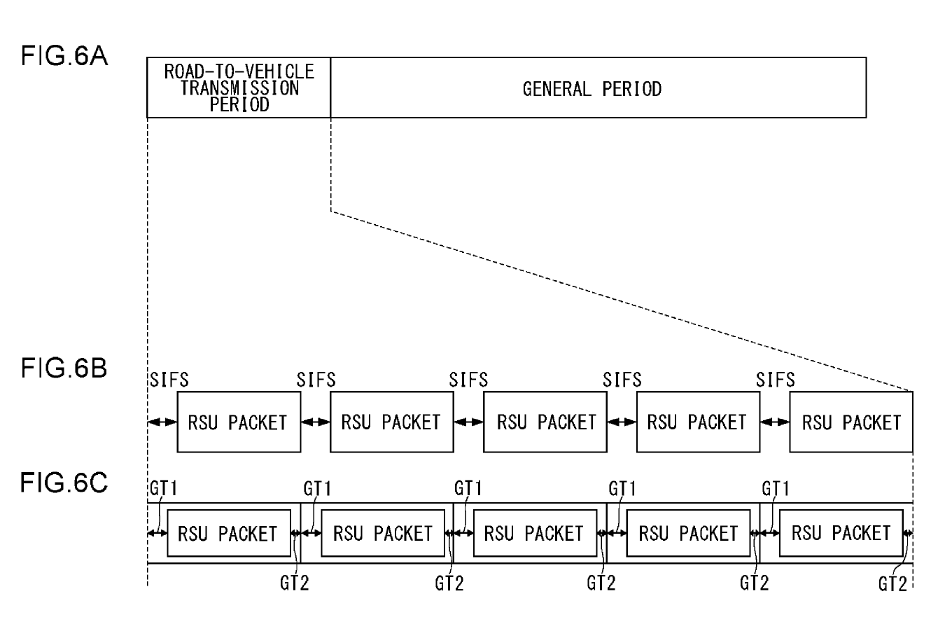

Next, a case in which the setting instruction is to use the first frame will be described. The generation unit 46 sets the road-to-vehicle transmission period in the subframe of the received subframe number and generates an RSU packet signal to be broadcast in the road-to-vehicle transmission period. Here, no control packet signal is generated. FIGS. 6(a) to 6(c) show a configuration of another subframe. FIG. 6(a) corresponds to a subframe when the first frame is used. As shown in FIG. 6(a), one subframe includes the road-to-vehicle transmission period and the general period in this order. FIG. 6(b) shows an arrangement of the packet signals in the road-to-vehicle transmission period. As shown in FIG. 6(b), a plurality of RSU packet signals are arranged in the road-to-vehicle transmission period and no control packet signal is arranged. Here, two adjacent packet signals are separated from each other by SIFS (Short Interframe Space). The road-to-vehicle transmission period may include a plurality of slots and a packet signal may be arranged in each slot as shown in FIG. 6(c) instead of the case of FIG. 6(b) in which packet signals are arranged with the SIFS distance in-between in the road-to-vehicle transmission period. As shown in FIG. 6(c), the RSU packet signals are arranged in the slots respectively. Here, a guard time GT1 is provided from the front of the slot and a packet signal is arranged following the guard time GT1. A guard time GT2 is provided following the packet signal. Let us return to FIG. 2. As described above, even when the first frame is used, the format of the message header generated by the generation unit 46 is the same as that shown in FIG. 5(b).

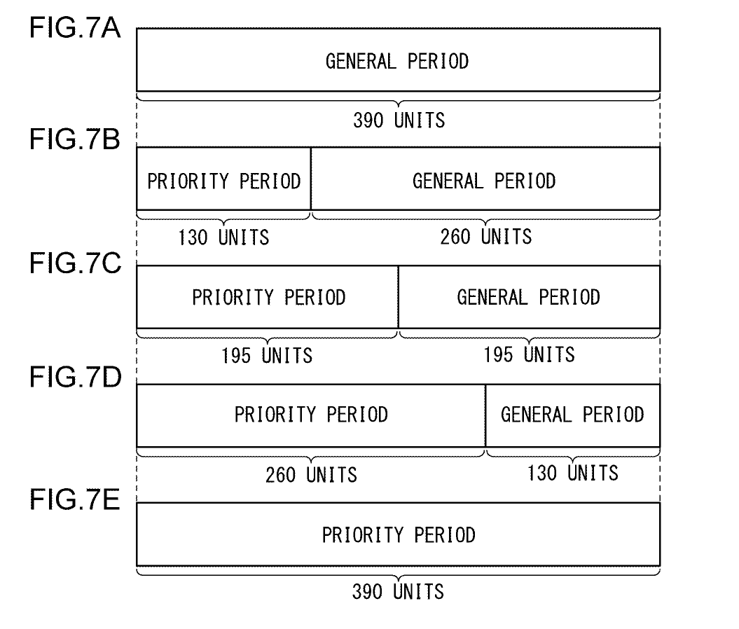

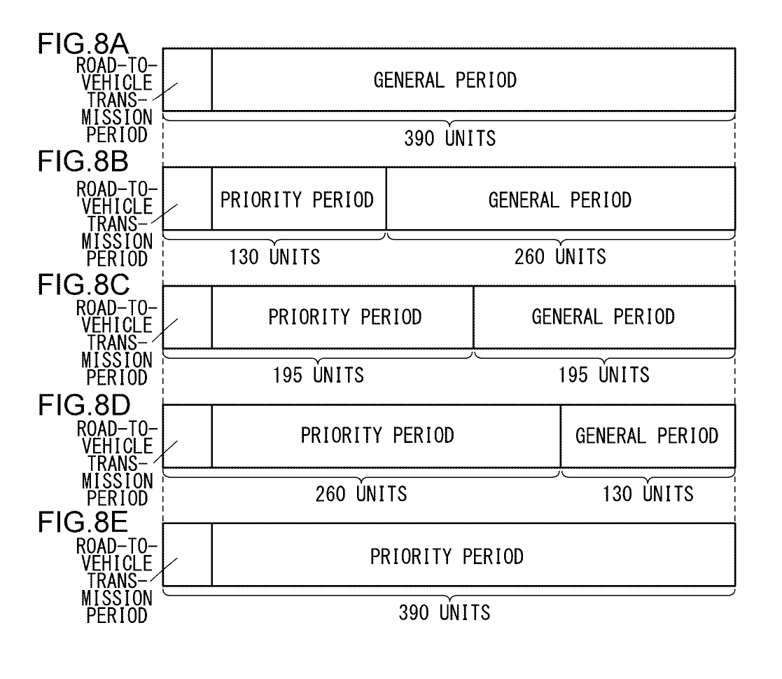

FIGS. 7(a) to 7(e) show setting examples of the inter-vehicle transmission period. FIG. 7(a) shows a case in which the priority-general ratio is “0:1”. This corresponds to the first frame. FIG. 7(b) shows a case in which the priority-general ratio is “1:2”. FIG. 7(c) shows a case in which the priority-general ratio is “1:1”. FIG. 7(d) shows a case in which the priority-general ratio is “2:1”. These correspond to the second frame. FIG. 7(e) shows a case in which the priority-general ratio is “1:0” and corresponds to a case in which the subframe includes only the priority period. FIGS. 8(a) to 8(e) show other setting examples of the inter-vehicle transmission period.

For example, the priority-general ratio is set as described below. The first one is a case in which data of the penetration rates of the terminal apparatus 14 that performs communication by only CSMA/CA and the terminal apparatus 14 that performs communication by CSMA/CA and TDMA are obtained from a manufacturer of the vehicles 12 or the like and the priority-general ratio is determined on the basis of the ratio of the penetration rates. The second one is a case in which statistical processing is performed on the basis of a total number of packet signals received in the priority period and a total number of packet signals received in the general period in the base station apparatuses 10 installed across the country, and the radio signal usage rates in the priority period and the general period are calculated. The usage rates are checked once in a few months by a business operating entity, and the ratio of the period which maintains a state in which the radio signal usage rate is high is increased. Further, to improve accuracy of the statistical processing, an access method used by the terminal apparatus 14 may be specified in the MAC header. In FIGS. 8(a) to 8(e), the road-to-vehicle transmission period is set in the subframe. Here, the priority-general ratios of FIGS. 8(a) to 8(e) are the same as those of FIGS. 7(a) to 7(e) respectively. As shown in FIGS. 8(a) to 8(e), the road-to-vehicle transmission period is set in the priority period shown by the priority-general ratio. Let us return to FIG. 2.

The processing unit 26 causes the modem unit 24 and the RF unit 22 to use broadcast to transmit a packet signal in the road-to-vehicle transmission period. In other words, the processing unit 26 uses broadcast to transmit an RSU packet signal in the base station broadcast period when the first frame is used and broadcasts a control packet signal and an RSU packet signal in the base station broadcast period when the second frame is used. The control unit 30 controls processes in the entire base station apparatus 10.

This configuration is realized by a given CPU of a computer, memory, and other LSIs in hardware, and realized by a program and the like loaded in the memory in software. Here, functional blocks realized by cooperation of the above elements are drawn. Therefore, those skilled in the art understand that the functional blocks are realized in various forms by only hardware, by only software, or by a combination of hardware and software.

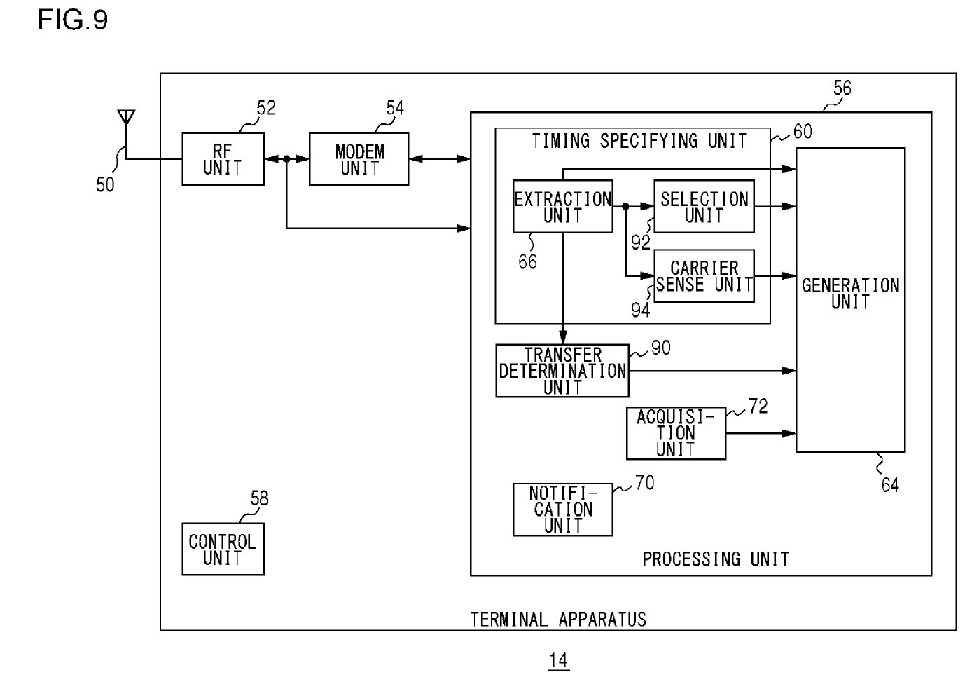

FIG. 9 shows a configuration of the terminal apparatus 14 mounted on the vehicle 12. The terminal apparatus 14 includes an antenna 50, an RF unit 52, a modem unit 54, a processing unit 56, and a control unit 58. The processing unit 56 includes a generation unit 64, a timing specifying unit 60, a transfer determination unit 90, a notification unit 70, and an acquisition unit 72. The timing specifying unit 60 includes an extraction unit 66, a selection unit 92, and a carrier sense unit 94. The antenna 50, the RF unit 52, and the modem unit 54 perform the same processes as those performed by the antenna 20, the RF unit 22, and the modem unit 24 in FIG. 2. Therefore, the differences will be mainly described here.

The modem unit 54 and the processing unit 56 receive a packet signal from another terminal apparatus 14 or another base station apparatus 10 that are not shown in FIG. 9. As described above, the modem unit 54 and the processing unit 56 receive a packet signal from the base station apparatus 10 in the road-to-vehicle transmission period. As described above, the modem unit 54 and the processing unit 56 receive a packet signal from another terminal apparatus 14 in the general period when the first frame is used and receive a packet signal from another terminal apparatus 14 in the priority period and the general period when the second frame is used.

When the demodulation result from the modem unit 54 is a packet signal from the base station apparatus 10 not shown in FIG. 9, the extraction unit 66 identifies timing of a subframe in which the road-to-vehicle transmission period is arranged. The extraction unit 66 generates a frame on the basis of the timing of the subframe and the content of a basic part in the message header in the packet signal, specifically the content of the RSU transmission period length. The frame may be generated in the same manner as in the frame definition unit 40 described above, so that the description is omitted here. As a result, the extraction unit 66 generates a frame synchronized with the frame generated by the base station apparatus 10.

The extraction unit 66 specifies a configuration of the subframe on the basis of the priority-general ratio in the message header of the packet signal. For example, units included in the priority period and units included in the general period are sorted so that a plurality of units included in one subframe are divided according to the priority-general ratio. Here, the priority period is arranged in the front portion of the subframe and the general period is arranged following the priority period. If the priority-general ratio is 0:1 as described above, the extraction unit 66 recognizes that the first frame is used. Otherwise, the extraction unit 66 recognizes that the second frame is used.

When the extraction unit 66 recognizes that the second frame is used, the extraction unit 66 determines to use the priority period. When the extraction unit 66 recognizes that the second frame is used, the extraction unit 66 determines to use the priority period. If no packet signal is received from the base station apparatus 10, that is, if the terminal apparatus 14 is located in the outside area 214, the extraction unit 66 selects timing that is not related to the configuration of the frame. When the extraction unit 66 selects timing that is not related to the configuration of the frame, the extraction unit 66 instructs the carrier sense unit 94 to perform carrier sense. When the extraction unit 66 selects the priority period, the extraction unit 66 outputs the detection results included in the data payload of the control packet signal to the selection unit 92. When the extraction unit 66 selects the general period, the extraction unit 66 outputs the timing of the frame and the subframe and information related to the inter-vehicle transmission period to the carrier sense unit 94.

The selection unit 92 receives the detection results from the extraction unit 66. As described above, the detection results show whether each of a plurality of slots included in the priority period is an empty slot, an in-use slot, or a collision slot. The selection unit 92 selects one of the empty slots. When the selection unit 92 has already selected a slot, if the slot is an in-use slot, the selection unit 92 continuously selects the slot. On the other hand, when the selection unit 92 has already selected a slot, if the slot is a collision slot, the selection unit 92 newly selects an empty slot . The selection unit 92 notifies the generation unit 64 of information related to the selected slot as the transmission timing. If there is no empty slot, the selection unit 92 may request the carrier sense unit 94 to determine the transmission timing. This corresponds to a case in which the priority period is preferentially used when the second frame is used.

The carrier sense unit 94 receives the timing of the frame and the subframe and the information related to the inter-vehicle transmission period. The carrier sense unit 94 measures interference power by performing carrier sense in the general period. Further, the carrier sense unit 94 determines the transmission timing in the general period on the basis of the interference power. Specifically, the carrier sense unit 94 stores a predetermined threshold and compares the interference power with the threshold. If the interference power is smaller than the threshold, the carrier sense unit 94 determines the transmission timing. When the carrier sense unit 94 is instructed to perform carrier sense by the extraction unit 66, the carrier sense unit 94 determines the transmission timing by performing the CSMA without considering the configuration of the frame. The carrier sense unit 94 notifies the generation unit 64 of the determined transmission timing.

The acquisition unit 72 includes a GPS receiver, a gyroscope, a vehicle speed sensor, and the like that are not shown in FIG. 9, and acquires a location, a moving direction, a moving speed, and the like (hereinafter collectively referred to as “position information”) of the vehicle 12 not shown in FIG. 9, that is, the vehicle 12 on which the terminal apparatus 14 is mounted, from data provided from the GPS receiver, the gyroscope, the vehicle speed sensor, and the like. The location is represented by latitude and longitude. A publicly known technique may be used to acquire the above information, so that the description of the technique is omitted here. The acquisition unit 72 outputs the position information to the generation unit 64.

The transfer determination unit 90 controls transfer of the message header. The transfer determination unit 90 extracts the message header from the packet signal. When the packet signal is directly transmitted from the base station apparatus 10, the number of reuse times is set to “0”. On the other hand, when the packet signal is transmitted from another terminal apparatus 14, the number of reuse times is set to “1 or more”. The transfer determination unit 90 selects a message header to be transmitted from the extracted message headers. Here, for example, a message header whose number of reuse times is the smallest is selected. The transfer determination unit 90 may generate a new message header by synthesizing contents included in a plurality of message headers. The transfer determination unit 90 outputs the selected message header to the generation unit 64. At this time, the transfer determination unit 90 increments the number of reuse times by “1”.

The generation unit 64 receives the position information from the acquisition unit 72 and receives the message header from the transfer determination unit 90. The generation unit 64 stores the position information in the data payload by using the MAC frame shown in FIGS. 5(a) and 5(b). The generation unit 64 generates a packet signal including a MAC frame, and uses broadcast to transmit the generated packet signal via the modem unit 54, the RF unit 52, and the antenna 50 at the transmission timing determined by the selection unit 92 or the carrier sense unit 94. The transmission timing is included in the inter-vehicle transmission period.

The notification unit 70 receives a packet signal from the base station apparatus 10 not shown in FIG. 9 in the road-to-vehicle transmission period and receives a packet signal from another terminal apparatus 14 not shown in FIG. 9 in the inter-vehicle transmission period. The notification unit 70 notifies a driver of an approach or the like of another vehicle 12 not shown in FIG. 9 via a monitor or a speaker according to the content of data stored in the packet signal as a process performed on the received packet. The control unit 58 controls processes in the entire terminal apparatus 14.

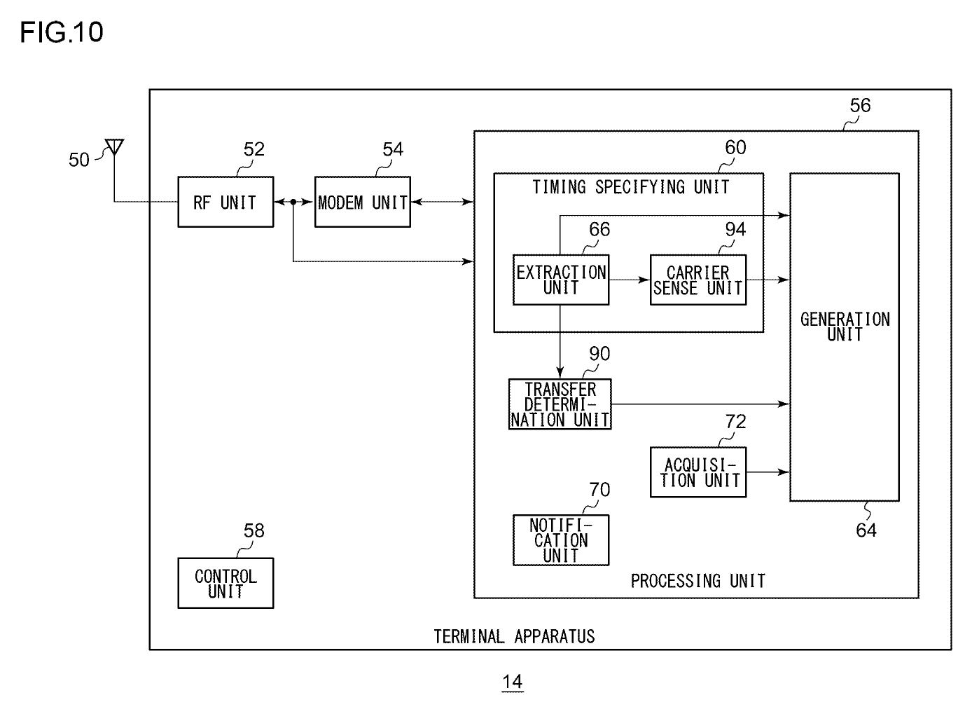

FIG. 10 shows a configuration of another terminal apparatus 14 mounted on the vehicle 12. The terminal apparatus 14 has a configuration in which the selection unit 92 is removed from the terminal apparatus 14 shown in FIG. 9. In other words, the terminal apparatus 14 shown in FIG. 10 corresponds to an older version of the terminal apparatus 14 shown in FIG. 9 and can perform only the communication by the CSMA/CA. Here, the difference from the terminal apparatus 14 shown in FIG. 9 will be mainly described. When a packet signal from the base station apparatus 10 is received, the extraction unit 66 determines to use the general period regardless of whether the first frame is used or the second frame is used. Here, if the second frame is used, the general period excluding the priority period is specified. Specifically, the carrier sense unit 94 sets NAV over the priority period. The process of the carrier sense unit 94 is the same as described above.

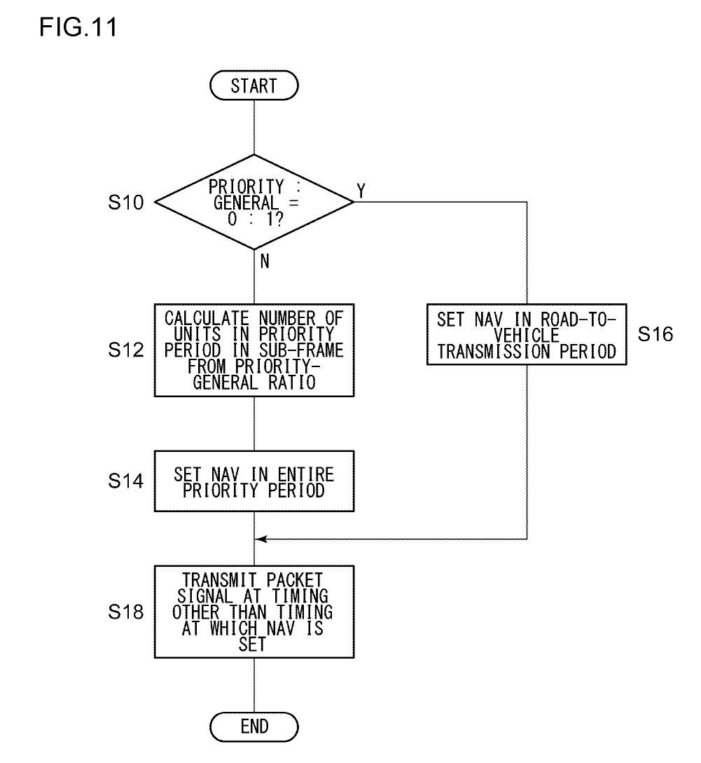

The operation of the communication system 100 having the above configuration will be described. FIG. 11 is a flowchart showing the transmission process of the terminal apparatus 14. This corresponds to the transmission process of the terminal apparatus 14 shown in FIG. 10, that is, the terminal apparatus 14 that can perform only the communication by the CSMA/CA. Also, this corresponds to the transmission process of the terminal apparatus 14 shown in FIG. 9 which can perform the communication by the CSMA/CA and the TDMA but is set to perform only the communication by the CSMA/CA. If the priority-general ratio is not 0:1 (N in S10), the carrier sense unit 94 calculates the number of units in the priority period in the subframe from the priority-general ratio (S12) and sets NAV in the entire priority period (S14). On the other hand, if the priority-general ratio is 0:1 (Y in S10), the carrier sense unit 94 sets NAV in the road-to-vehicle transmission period (S16). The generation unit 64, the modem unit 54, and the RF unit 52 transmit a packet signal at timing other than timing at which NAV is set (S18).

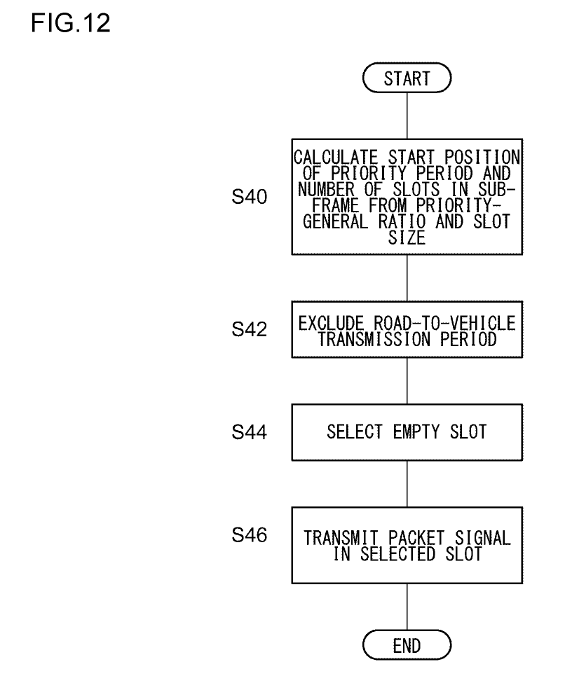

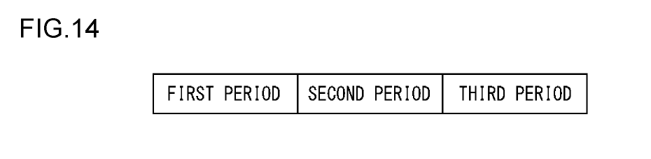

FIG. 12 is a flowchart showing the transmission process in the terminal apparatus in FIG. 14. This corresponds to the transmission process of the terminal apparatus 14 shown in FIG. 9, that is, the terminal apparatus 14 that can perform the communication by the CSMA/CA and the TDMA. The selection unit 92 calculates a start position of the priority period and the number of slots in the subframe from the priority-general ratio and the slot size (S40). The selection unit 92 excludes the road-to-vehicle transmission period (S42) and selects an empty slot (S44). The generation unit 64, the modem unit 54, and the RF unit 52 transmit a packet signal in the selected slot (S46).

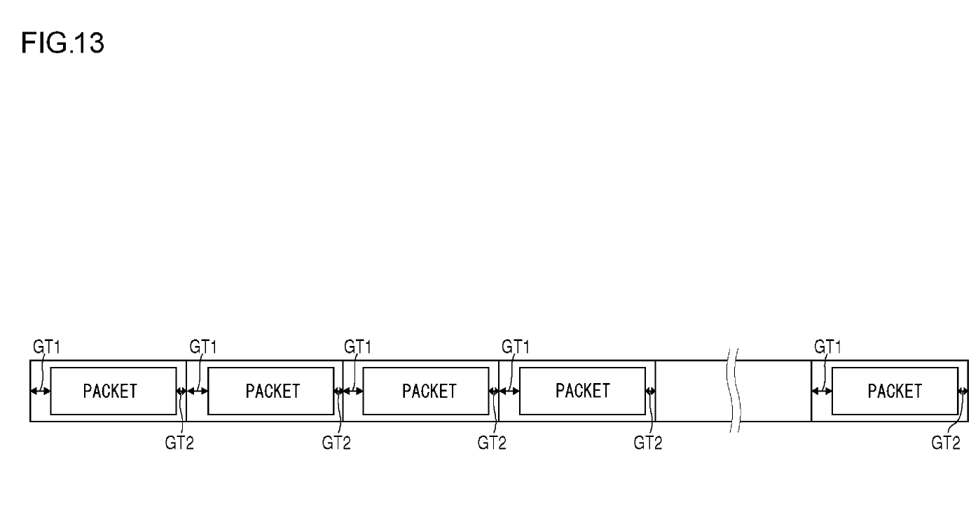

FIG. 13 is a diagram showing another configuration of the priority period shown in FIG. 4(b). As shown in FIG. 13, in each slot, a guard time GT1 is provided in front of the packet signal and a guard time GT2 is provided behind the packet signal. The selection unit 92 in FIG. 9 performs carrier sense in the guard time GT1 when the timing of the selected slot is reached. If no interference signal is detected in the carrier sense, the selection unit 92 selects the slot as the transmission timing. Here, the GT1 is set to be longer than a delay time estimated in the wireless transmission path. Further, the GT1 is set to be shorter than a time period of the carrier sense of the carrier sense unit 94 in FIG. 9.

According to the embodiment of the present invention, a message header having a common format is used regardless of whether the first frame is used or the second frame is used, so that it is possible to prevent the format of the message header from being changed. Since a message header having a common format is used, the message header can be used without change even when a state in which the first frame is used is changed to a state in which the second frame is used. The format of the message header is not changed, so that a change from the first frame to the second frame is flexibly performed. Even a terminal apparatus that uses only the CSMA/CA can transmit a packet signal in the general period of the second frame. Terminal apparatuses that use only the CSMA/CA can be introduced in an early stage, so that it is possible to rapidly expand the use of the communication system. A terminal apparatus that uses the TDMA in addition to the CSMA/CA preferentially uses the priority period, so that the collision probability of the packet signals can be reduced.

The time division multiplexing by the slots is performed in the priority period, so that the error rate can be reduced. The CSMA/CA is performed in the general period, so that the number of terminal apparatuses can be flexibly adjusted. The subframe used by another base station apparatus is identified on the basis of not only a packet signal directly received from the other base station, but also a packet signal received from a terminal apparatus, so that the identification accuracy of the subframe in use can be improved. The identification accuracy of the subframe in use is improved, so that it is possible to reduce the collision probability between packet signals transmitted from base station apparatuses. The collision probability between packet signals transmitted from base station apparatuses is reduced, so that a terminal apparatus can correctly recognize the control information. The control information is correctly recognized, so that the road-to-vehicle transmission period can be correctly recognized. The road-to-vehicle transmission period is correctly recognized, so that the collision probability of packet signals can be reduced.

A subframe other than a subframe in use is preferentially used, so that it is possible to reduce the probability that a packet signal is transmitted at the same timing as that of a packet signal from another base station apparatus. When all subframes are used by other base station apparatuses, a subframe whose received power is small is selected, so that it is possible to suppress the effects of interference of the packet signals. As the received power from another base station apparatus which is a transmission source of the control information relayed by a terminal apparatus, the received power of the terminal apparatus is used, so that an estimate process of the received power can be simply performed.

The present invention has been described on the basis of the embodiment. The embodiment is an example, and it will be understood by those skilled in the art that various modified examples are possible with combinations of respective constituent elements and respective processes thereof and that such modified examples are within the scope of the present invention.

In the embodiment of the present invention, each base station apparatus 10 individually sets the priority-general ratio. However, it is not limited to this, and for example, the base station apparatuses 10 that form an overlapped area 212 may use a common priority-general ratio. Specifically, when the selection unit detects a subframe that is used by another base station apparatus 10, the priority-general ratio of the other base station apparatus 10 is acquired. The setting unit 48 sets the same value as that of the acquired priority-general ratio. According to this modified example, a common priority-general ratio is used by the base station apparatuses 10 that form the overlapped area 212, so that it is possible to reduce the probability that a packet signal in the priority period collides with a packet signal in the general period.

It is possible to define a group by a plurality of base station apparatuses 10 that form the overlapped area 212 and another group by a plurality of other base station apparatuses 10 and set the priority-general ratio for each group. Here, the priority-general ratio is set so that the priority period is long for a group having a large number of population and a large number of vehicles 12. According to this modified example, priority-general ratios suited to neighboring areas 212 can be set.

In the embodiment of the present invention, the subframe includes the first period that is the priority period and the second period that is the general period. However, it is not limited to this, and for example, the subframe may include a third period in addition to the first period and the second period. FIG. 14 shows a configuration of a subframe according to a modified example of the present invention. The first period, the second period, and the third period are arranged from the front of the subframe. The third period is used for communication whose purpose is different from those of the first period and the second period. For example, unicast communication is performed. Further, to notify of the presence and the period of the third period, information indicating those is included in the message header. The third period and either one of the first period and the second period may be included in the subframe. The road-to-vehicle transmission period may be included in the front portion of the subframe. According to this modified example, various forms of communication can be performed.

What is claimed is:

1. Abase station apparatus for controlling communication between terminals, the base station apparatus comprising:
a generation unit configured to generate control information; and
a broadcast unit configured to broadcast a packet signal including the control information generated by the generation unit,
wherein
the generation unit puts information related to a ratio between a first period and a second period that form a frame into the control information.

2. The base station apparatus according to claim 1, further comprising:
a selection unit configured to define a first frame in which a base station broadcast period for the base station apparatus to broadcast a packet signal and a second period which has a predetermined length and in which a terminal apparatus can broadcast a packet signal are time multiplexed, to define a second frame in which the base station broadcast period, the second period, and a first period different from the second period are time multiplexed, and to select use of the first frame or the second frame,
wherein the generation unit reflects the selection by the selection unit to the ratio.

3. The base station apparatus according to claim 1, wherein
the generation unit sets the ratio between the first period and the second period that form a frame to 0:1.

4. The base station apparatus according to claim 2, wherein
the generation unit sets the ratio between the first period and the second period that form a frame to 0:1.

5. The base station apparatus according to claim 2, wherein
the first period included in the second frame that can be selected by the selection unit is formed by a plurality of slots and a terminal apparatus can broadcast a packet signal in each slot,
the generation unit generates control information which is defined by the same format and which includes at least information related to the base station broadcast period regardless of the selection by the selection unit, and
the broadcast unit broadcasts a packet signal including the control information generated by the generation unit in the base station broadcast period.
